(19) United States
(12) Patent Application Publication
(10) Pub. No.: US 2007/0211335 A1
(43) Pub. Date: Sep. 13, 2007

(54) Optical Member, Method Of Manufacture Thereof, And Image Display Therewith

(75) Inventors: Hideo Ikeda, Osaka (JP); Kouji Ishizaki, Osaka (JP); Minoru Itou, Osaka (JP); Kazuo Kitada, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 11/547,914

(22) PCT Filed: Apr. 8, 2005
(86) PCT No.: PCT/JP05/06932

§ 371 Date: Oct. 10, 2006

(30) Foreign Application Priority Data
Apr. 13, 2004 (JP) 2004-118167

(51) Int. Cl. G02B 5/30; B29D 11/00

(52) U.S. Cl. 359/485; 216/24

(57) ABSTRACT

According to the invention, the optical film is processed into circular shape as stated above. Thus, optical members with high versatility can be produced without being affected by the optical film-specific optical axis, and optical members that allows easy inventory control can be provided with no reduction in production efficiency. And a method of processing a long size optical film into a circular shape, subsequently processing the optical film processed into the circular shape into an arbitrary shape, also allows a fine tuning of its optical axis even after it is produced from the long size optical film, therefore, optical members with a high degree of flexibility in design and with high versatility can be provided.

### TECHNICAL FIELD

The invention relates to an optical member for use in image displays such as liquid crystal displays (LCDs), electroluminescence displays (ELDs), plasma displays (PDs), and field emission displays (FEDs), and to a method of producing the optical member. The invention also relates to an image display using the optical member.

### BACKGROUND ART

A conventional method of producing a thin optical member for use in image displays, such as a polarizing plate and a retardation plate for use in liquid crystal displays, generally includes forming a pressure-sensitive adhesive layer or an adhesive layer on a long size optical member (optical film), attaching a release film or the like, and punching into a rectangular shape of the size and conditions that customers need from the optical member with the pressure-sensitive adhesive or adhesive layer protected by the release film or includes punching such shapes from the optical member itself without any pressure-sensitive adhesive or adhesive layer (for example, Japanese Patent Application Laid-Open (JP-A) No. 06-289221). Such an optical member is then subjected to a post-process such as punching of arbitrary size, cutting of end sides, and bonding to any other optical member and then incorporated as a part of an image display.

In order to produce the intended optical properties, the direction of the in-plane optical axis of the optical member has to be aligned before the optical member is incorporated into an image display. For example, when a polarizing plate is incorporated into a liquid crystal display, the optical axes of the polarizing plate, specifically the absorption axis and the transmission axis for polarized light are adjusted depending on the liquid crystal mode of the liquid crystal cell. For example, in the case of an STN mode liquid crystal cell, the absorption axis of the polarizing plate is set at 60° with respect to the long side of the rectangle. As mentioned above, the polarizing plate for use in liquid crystal displays or the like is produced by cutting in such a manner that the optical axis is arranged in a prescribed direction. Thus, the area yield of the polarizing plate is low, and there is a problem in which a large amount of industrial waste can be generated.

In order to set adjust the optical axis direction as mentioned above, when the long size optical member is processed for punching, the punching is performed altering and controlling the type or position of the punching blade depending on the desired size or the desired angle of the optical axis. Such a process of alteration and control involves an interruption of the process flow and thus is complex and time-consuming. Additionally, the desired optical axis angle varies with the characteristics designed by the customer, the liquid crystal mode and the like, and the size of the optical member also varies, such as cellular phone sizes and large-screen TV sizes, which requires changing the punching blade every time. The labor and time do not directly contribute to the productivity, and thus the process is desired to be as efficient as possible. On the grounds mentioned above, an increase in the variety of products leads to carrying a huge inventory of various products for responding to customer demands.

### DISCLOSURE OF INVENTION

It is therefore an object of the invention to provide an optical member, which can solve the above problems, can be produced with high efficiency and produced into an arbitrary optical member as necessary and to provide a method of manufacture thereof. It is another object of the invention to provide an image display using such an optical member.

### Means for Solving the Problems

As a result of earnest investigation for solving the above problems, the inventors have found that the objects can be achieved by the optical member described below and by the method of producing the optical member described below and have completed the invention.

That is, this invention relates to an optical member, comprising at least one piece of an optical film, wherein the optical film has an optical axis and a circular outer shape.

In the optical member, the optical film further comprising at least one layer selected from an optical layer, an adhesive layer and a pressure-sensitive adhesive layer can be used.

An in-plane aspect ratio (maximum length/minimum length) of the circular shape in the optical member is preferably 2 or less.

As the optical film used in the optical member, the optical film comprising at least one selected from a polarizing plate, a retardation plate, a viewing angle compensation film, a brightness enhancement film, and a polarization-converting element can be used.

As the optical film used in the optical member, a laminate comprising at least two optical films can be used. As the optical film of the optical member, a laminate comprising a polarizing plate and another optical film of at least one element that is other than the polarizing plate and selected from a retardation plate, a viewing angle compensation film, a brightness enhancement film, and a polarization-converting element can be used.

This invention also relates to a method (1) of producing an optical member, comprising the steps of:

(A) processing a long size optical film having an optical axis into a circular shape; and

(B) processing the optical film processed into the circular shape into an arbitrary shape.

In the method (1) of producing the optical member, the optical film further comprising at least one layer selected from an optical layer, an adhesive layer and a pressure-sensitive adhesive layer can be used.

In the method (1) of producing the optical member, an in-plane aspect ratio (maximum length/minimum length) of the circular shape in the step (A) is preferably 2 or less.

In the method (1) of producing the optical member, the arbitrary shape in the step (B) can be a rectangular shape.

As the optical film used in the method (1) of producing the optical member, the optical film comprising at least one selected from a polarizing plate, a retardation plate, a viewing angle compensation film, a brightness enhancement film, and a polarization-converting element can be used.

As the optical film used in the method (1) of producing the optical member, a laminate comprising at least two optical films can be used. As the optical film of the optical member, a laminate comprising a polarizing plate and another optical film of at least one element that is other than the polarizing plate and selected from a retardation plate, a viewing angle compensation film, a brightness enhancement film, and a polarization-converting element can be used.

This invention also relates to a method (2) of producing an optical member comprising a laminate having at least two optical films, comprising the steps of:

(A) processing each of at least two optical films into a circular shape;

(C) laminating the at least two optical film processed into the circular shape obtained in the step (A); and

(B) processing the laminated optical films obtained in the step (C) into an arbitrary shape,

the step (A) comprising at least the steps of:

(A1) processing a first long size optical film having an optical axis into a circular shape; and

(A2) processing a second long size optical film having an optical axis into a circular shape, and

the step (C) comprising at least the step of:

laminating the first and the second optical films processed into the circular shapes such that their optical axes make a prescribed angle.

This invention also relates to a method (3) of producing an optical member comprising a laminate having at least two optical films, comprising the steps of:

(A) processing each of at least two optical films into a circular shape;

(B) further processing each of the at least two optical film processed into the circular shape obtained in the step (A) into an arbitrary shape; and

(C) laminating the at least two arbitrary shaped optical films obtained in the step (B);

the step (A) comprising at least the steps of:

(A1) processing a first long size optical film having an optical axis into a first circular shape; and

(A2) processing a second long size optical film having an optical axis into a second circular shape, and

the step (C) comprising at least the step of:

laminating the first and the second optical film processed into the arbitrary shape such that their optical axes make a prescribed angle.

In the method (2) or (3) of producing the optical member, the optical film further comprising at least one layer selected from an optical layer, an adhesive layer and a pressure-sensitive adhesive layer can be used.

In the method (2) or (3) of producing the optical member, an in-plane aspect ratio (maximum length/minimum length) of the circular shape in the step (A) is preferably 2 or less.

In the method (2) or (3) of producing the optical member, the arbitrary shape in the step (B) can be a rectangular shape.

As the optical film used in the method (2) or (3) of producing the optical member, the optical film can be at least one selected from a polarizing plate, a retardation plate, a viewing angle compensation film, a brightness enhancement film, and a polarization-converting element.

In the method (2) or (3) of producing the optical member, first optical film is suitable for a polarizing plate or a retardation plate, and the second optical film is suitable for other than the polarizing plate and at least one selected from a retardation plate, a viewing angle compensation film, a brightness enhancement film, and a polarization-converting element.

Further this invention relates to an optical member, produced by the method (1), (2) or (3).

Further this invention relates to an image display, comprising the above optical member.

### Effects of the Invention

According to the invention, the optical film is processed into circular shape as stated above. Thus, optical members with high versatility can be produced without being affected by the optical film-specific optical axis, and optical members that allows easy inventory control can be provided with no reduction in production efficiency. The optical member of the invention also allows a fine tuning of its optical axis even after it is produced from the long size optical film. According to the invention, therefore, optical members with a high degree of flexibility in design and with high versatility can be provided. For the reason as stated above, cost reduction is also possible. Therefore, the use of such an optical member allows the production of lower-cost image displays.

Some specific effects are also produced as described below. The frequency of changing the types of blades for punching from the long size optical film can be reduced so that the time it takes from when the long size optical film is prepared until the optical member is delivered through the process can be significantly reduced. The types of the punching blades can also be reduced so that the cost for the storage place and purchase can be reduced. The punched circular shape optical films to be further processed can be almost standardized in size and shape so that preparation for the processing can be easily performed. The material use efficiency of the invention can be higher than in punching rectangular shape optical film from the long size optical film, and thus the area yield can also be improved.

### BRIEF DESCRIPTION OF DRAWINGS

FIG. 1 is a schematic diagram for cutting showing an example of the process of cutting circular shape optical films from a long size optical film according to the invention;

FIG. 2 is a schematic diagram for cutting showing an example of the process of processing a circular shape optical film into a single rectangular shape optical film;

FIG. 3 is a schematic diagram for cutting showing an example of the process of processing a circular shape optical film into two or more rectangular shape optical films;

FIG. 4 is a schematic diagram for cutting showing an example of the conventional process of cutting rectangular shape optical films each with an axial angle of 60° from a long size optical film; and

FIG. 5 is a schematic diagram for cutting showing another example of the conventional process of cutting rectangular shape optical films with an axial angle of 0° from a long size optical film.

### DESCRIPTION OF REFERENCE NUMERALS

In the drawings, reference numeral 1 represents a long size ptical film, 2 circular shape optical films, 3 rectangular shape optical films, and 4 a mark for indicating the optical axis direction.

### BEST MODE FOR CARRYING OUT THE INVENTION

The optical member according to the invention includes an optical film that has an optical axis and a circular outer shape. For example, the circular shape optical film may be obtained by the step (A) of processing a long size optical film having an optical axis into circular shape. The optical axis is a directional axis along which certain optical properties are provided in the plane of the optical film. The optical film may be uniaxial or multi-axial. For example, the optical axis of a polarizing plate is generally an absorption axis along which polarized light is absorbed, while the optical axis of a retardation plate is generally a slow axis.

The optical film having a circular outer shape is less dependent on the optical axis direction than the long size optical film having an optical axis and thus can form an optical member with improved versatility. The circular shape is preferably a perfect circle in terms of its high versatility but does not have to be a perfect circle depending on usage. The circular shape may include an elliptical shape or may contain a linear portion. In such cases, the in-plane aspect ratio of the circular shape (maximum length/minimum length) is preferably 2 or less, more preferably 1.5 or less, still more preferably 1.2 or less. As stated above, the aspect ratio is most preferably 1. Particularly, in a case where the circumference of the optical film has no linear portion and entirely consists of curved portions, the optical film has the effect of reducing an impact on the end portion at the time of transfer or the like. If necessary, such an optical member may have a linear portion or a mark formed by notching, printing or the like, which is for identifying its optical axis direction, its class or the like, as long as the effects of the invention are not ruined.

While the circular shape optical film may be used as an optical member without being processed, the circular shape optical film is preferably subjected to some process before use and may be subjected to the step (B) of processing it into an arbitrary shape. While the circular shape optical film may be processed into any shape, the circular shape optical film is preferably processed into a rectangular piece(s) such as a square piece and a rectangle piece, because such a piece can be easily used for image displays and is easy to handle.

The long size optical film refers to a continuous optical film having uniform performance from which at least two pieces of the circular shape optical film can be obtained. For continuous production, the long size optical film preferably has a length of at least 5 m in the flow direction.

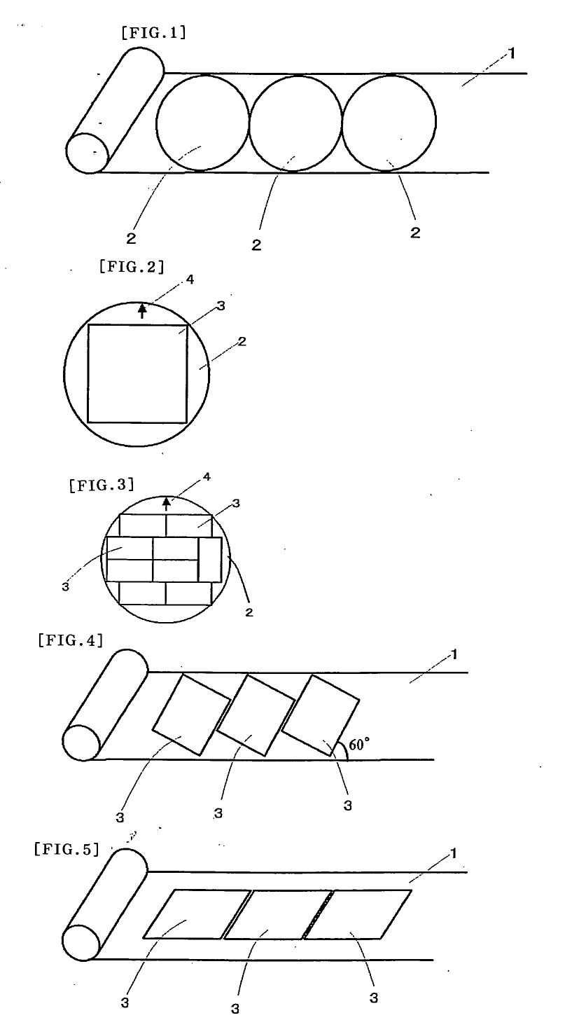

Referring to FIG. 1, for example, the circular shape optical films 2 are cut in the form of circular shapes from the long size optical film 1. Referring to FIG. 2 or 3, the circular shape optical film 2 is then preferably formed into arbitrary shape(s) such a rectangular shape(s) 3 by cutting the film 2, by cutting end sides or by any other process and then used for image displays or the like as needed.

The optical film for forming the optical member of the invention may be a single piece or a laminate including at least two optical films. Also when the optical member of the invention is a laminate including at least two optical films, the optical film may be produced by the production method (1) which includes previously subjecting a laminate to the step (A) and subjecting the laminate to the step (B) as described above. When the optical member of the invention is a laminate including at least two optical films, however, the optical member of the invention is preferably prepared by the production method (2) or (3), particularly preferably by the production method (2), in terms of the fine-tuning of the optical axis of each optical film or in terms of area yield with respect to the optical film.

In the production method (2) or (3), at least two optical films are each subjected to the step (A) of processing each film into circular shape. Specifically, the step (A) may includes at least the step (Al) of processing a first long size optical film having an optical axis into circular shape and the step (A2) of processing a second long size optical film having an optical axis into circular shape. In the production method (2), the step (C) of laminating at least two pieces of the circular-shaped optical films obtained in the step (A) may be performed, and then the step (B) of processing the optical film laminate obtained in the step (C) into an arbitrary shape may be performed. In the production method (3), the step (B) of processing each of at least two pieces of the circular-shaped optical films obtained in the step (A) into an arbitrary shape may be performed, and then the step (C) of laminating at least two shaped optical film pieces obtained in the step (B) may be performed. In the step (C) of the production method (2), at least the first and second circular-shaped optical film pieces are laminated such that their optical axes make a prescribed angle. In the step (C) of the production method (3), at least the first and second shaped optical film pieces are laminated such that their optical axes make a prescribed angle. The invention is preferably applied to the case where arbitrary shaped pieces, specifically rectangular pieces, of the first and second optical films differ in the direction of the optical axis with respect to the rectangular shape. The lamination can be achieved using a pressure-sensitive adhesive layer, an adhesive layer or the like.

The method (A) of processing the long size optical film into circular shape or the method (B) of processing the circular shape optical film into an arbitrary shape may be, but not limited to, any appropriate known method such as punching and cutting. Examples of such a method include a punching method with a Thomson blade and a cutting method using a cutter with a round blade, a disk blade or the like, a laser beam, or a water pressure.

When the optical film is subjected to punching or cutting as described above, the end side of the optical film is preferably subjected to cutting processing for the purpose of removing whisker-like chips or very small chipped portions. Any appropriate known method may be used for the cutting processing. For example, a method is preferably used that includes the steps of stacking the cut pieces of the optical member to form a laminate with a certain thickness and cutting the laminate with a rotary blade by a copying method.

While the optical film may be any sheet-shaped material having an optical axis or optical axes, thin optical films are preferably used. Examples thereof include optical films for use in forming image displays as described later. The optical film may further include at least one layer selected from an optical layer, an adhesive layer and a pressure-sensitive adhesive layer. An optical film having an adhesive or pressure-sensitive adhesive layer on at least one side is particularly preferred, because it can easily be bonded to any other component in a post-process without the formation of any adhesive or pressure-sensitive adhesive layer after the cutting-off process. In this case, the adhesive or pressure-sensitive adhesive layer is preferably protected by a release film or the like.

The optical film may be the product for use in forming image displays. Examples of the type of the optical film include, but are not limited to, polarizing plates, retardation plates (including wave plates (λplates) such as half-wave plates and quarter wavelength plates), viewing angle compensation films, brightness enhancement films, and polarization-converting elements. Any of these optical films may be used in the form of a laminate such as a laminate of the polarizing plate and the retardation plate, which may be used as a circularly polarizing plate or an elliptically polarizing plate. An optical layer-containing laminate may also be used as the optical film. Examples of the optical layer include an organic electro-luminescent light-emitting material, a reflecting plate, and a transflective plate.

The above-described polarizer polarizing plate generally comprises a polarizer and a transparent protective layer prepared at least on one side thereof. The polarizer is, but not limited to, various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type orientation films, such as dehydrated polyvinyl alcohol and dehydrochlorinated polyvinyl chloride, or the like may be mentioned. In these, a polyvinyl alcohol type film on which dichromatic materials such as iodine or the like, is contained is suitably used. Although thickness of polarizer is, but not limited to, the thickness of about 5 to 80 μm is commonly adopted.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol type film may be dipped in water and rinsed if needed. By rinsing polyvinyl alcohol type film with water, effect of preventing un-uniformity, such as unevenness of dyeing, is expected by making polyvinyl alcohol type film swelled in addition that also soils and blocking inhibitors on the polyvinyl alcohol type film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

Materials forming a transparent protective layer prepared at least on one side a polarizer thereof is preferably used a material having outstanding transparency, mechanical strength, heat stability, outstanding moisture interception property and isotropic property, or the like. For example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming a protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; arylate type polymers; polyoxymethylene type polymers; epoxy type polymers; or blend polymers of the polymers may be mentioned. The transparent protective layer may a cured layer formed by curing a thermosetting or ultraviolet-curable resin such as an acrylic, urethane, acrylic urethane, epoxy, or silicone resin. A resin having a hydroxyl group which is reactive with an isocyanate crosslinking agent is particularly preferred, and cellulose polymers are specifically preferred. A thickness of a transparent protective layer is, but not limited to, in general, 500 μm or less, preferably 1 to 300 μm, and especially preferably 5 to 200 μm.

Moreover, as the transparent protective layer, polymer films which is described in Japanese Patent Laid-Open Publication No. 2001-343529 (WO 01/37007), for example, resin compositions including (A) thermoplastic resins having substituted and/or non-substituted imido group is in side chain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions or the like may be used.

Moreover, it is preferable that the transparent protective layer may have as little coloring as possible. Accordingly, a protective layer having a retardation value in a film thickness direction represented by Rth=[(nx+ny)/2−nz]×d of −90 nm to +75 nm (where, nx and ny represent principal indices of refraction in a film plane, nz represents refractive index in a film thickness direction, and d represents a film thickness) may be preferably used. Thus, coloring (optical coloring) of polarizing plate resulting from a protective layer may mostly be cancelled using a protective film having a retardation value (Rth) of −90 nm to +75 nm in a thickness direction. The retardation value (Rth) in a thickness direction is preferably −80 nm to +60 nm, and especially preferably −70 nm to +45 nm.

Examples of the retardation plate include a birefringent film produced by uniaxially or biaxially stretching a polymer film, an alignment film produced by aligning and then crosslinking or polymerizing a liquid crystal monomer, an alignment film of a liquid crystal polymer, and an alignment layer of a liquid crystal polymer supported on a film. For example, the stretching process may be performed by a roll stretching method, a long gap alignment stretching method, a tenter stretching method, a tubular stretching method, or the like. The stretch ratio is generally from about 1.1 to about 3 times in the case of uniaxial stretching. The thickness of the retardation plate is generally, but not limited to, from 10 to 200 μm, preferably from 20 to 100 μm.

Examples of the polymer film material include polyvinyl alcohol, polyvinyl butyral, polymethylvinylether, polyhydroxyethyl acrylate, hydroxyethyl cellulose, hydroxypropyl cellulose, methyl cellulose, polycarbonate, polyarylate, polysulfone, polyethylene terephthalate, polyethylene naphthalate, polyether-sulfone, polyphenylene sulfide, polyphenylene oxide, polyarylsulfone, polyvinyl alcohol, polyamide, polyimide, polyolefin, polyvinyl chloride, cellulose polymers, a variety of binary or ternary copolymers thereof, graft copolymers thereof, and any blends thereof. The polymer film may be turned to an oriented product (stretched film) by stretching or the like.

The liquid crystal monomer may be either lyotropic or thermotropic. In terms of workability, the thermotropic liquid crystal monomer is preferred, and examples thereof include monomers whose basic skeleton is a stilbene derivative, a phenyl benzoate derivative or a biphenyl derivative, in which a functional group such as acryloyl, vinyl or epoxy is introduced. For example, such a liquid crystal monomer is preferably subjected to a process including the steps: of aligning the monomer by an appropriate known method such as a method using heat or light, a method of rubbing the surface of a substrate, and a method of adding an alignment assisting agent; and then crosslinking or polymerizing the monomer in the aligned state with light, heat, electron beams, or the like to fix the alignment.

Examples of the liquid crystal polymer include a variety of main-chain or side-chain type polymers each having a conjugated linear group (mesogenic group) that is introduced in the main or side chain to impart liquid crystal orientation properties. Examples of the main-chain type liquid-crystalline polymer include polymers each having a structure in which a mesogenic group is connected via a spacer moiety for imparting flexibility, such as nematically-oriented polyester liquid-crystalline polymers, discotic polymers, and cholesteric polymers. Examples of the side-chain type liquid-crystalline polymer include polymers each having a main chain skeleton of polysiloxane, polyacrylate, polymethacrylate, or polymalonate, and a side chain of a mesogenic moiety that is linked via a spacer moiety of a conjugated group and composed of a nematic orientation-imparting para-substituted cyclic compound unit. For example, any of these liquid crystal polymers may be aligned by a process including the steps of: spreading a liquid-crystalline polymer solution on an oriented surface such as a rubbed surface of a thin film of polyimide, polyvinyl alcohol or the like formed on a glass plate, and a surface of obliquely-vapor-deposited silicon oxide; and heating the solution.

The retardation plate may have an appropriate retardation depending on the purpose of use, such as compensation for coloration, which can be caused by the birefringence of various kinds of wavelength plates or liquid crystal layers, and compensation for viewing angle. At least two types of the retardation plates may be laminated in order to control optical properties such as retardation.

A description of the elliptically polarizing plate or circularly polarizing plate on which the retardation plate is laminated the polarizing plate will be made in the following paragraph. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflection type liquid crystal display that provides a colored picture, and it also has function of anti-reflection.

A reflection plate is used as a reflection polarizing plate in which the reflection plate is directly given to the protective film of the polarizing plate, or a reflective sheet constituted by preparing a reflective layer on the suitable film for the transparent film. In addition, since a reflective layer is usually made of metal, it is desirable that the reflective side is covered with a protective film or a polarizing plate or the like when used, from a viewpoint of preventing deterioration in reflectance by oxidation, of maintaining an initial reflectance for a long period of time and of avoiding preparation of a protective layer separately or the like.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal or the like is, if required, attached to one side of a polarizing plate through a transparent protective layer or the like.

As an example of a reflection type polarizing plate, a plate may be mentioned on which, if required, a reflective layer is formed using a method of attaching a foil and vapor deposition film of reflective metals, such as aluminum, to one side of a matte treated protective film. Moreover, a different type of plate with a fine concavo-convex structure on the surface obtained by mixing fine particle into the protective film, on which a reflective layer of concavo-convex structure is prepared, may be mentioned. The reflective layer that has the fine concavo-convex structure diffuses incident light by random reflection to prevent directivity and glaring appearance, and has an advantage of controlling unevenness of light and darkness or the like. Moreover, the protective film containing the fine particle has an advantage that unevenness of light and darkness may be controlled more effectively, as a result that an incident light and its reflected light that is transmitted through the film are diffused. A reflective layer with fine concavo-convex structure on the surface effected by a surface fine concavo-convex structure of a protective film may be formed by a method of attaching a metal to the surface of a transparent protective layer directly using, for example, suitable methods of a vacuum evaporation method, such as a vacuum deposition method, an ion plating method, and a sputtering method, and a plating method or the like.

A viewing angle compensation film is a film for extending viewing angle so that a picture may look comparatively clearly, even when it is viewed from an oblique direction not from vertical direction to a screen. As such a viewing angle compensation retardation plate, in addition, a film having birefringence property that is processed by uniaxial stretching or orthogonal bidirectional stretching and a bidriectionally stretched film as inclined orientation film or the like may be used. As inclined orientation film, for example, a film obtained using a method in which a heat shrinking film is adhered to a polymer film, and then the combined film is heated and stretched or shrunk under a condition of being influenced by a shrinking force, or a film that is oriented in oblique direction may be mentioned. The viewing angle compensation film is suitably combined for the purpose of prevention of coloring caused by change of visible angle based on retardation by liquid crystal cell or the like and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side or the like, comes in. The polarizing plate, which is obtained by laminating a brightness enhancement film to a polarizing plate, thus does not transmit light without the predetermined polarization state and reflects it, while obtaining transmitted Right with the predetermined polarization state by accepting a light from night sources, such as a backlight. This polarizing plate makes the night reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display or the like, and as a result luminosity may be improved. That is, in the case where the light enters through a polarizer from backside of a liquid crystal cell by the back light or the like without using a brightness enhancement film, most of the light, with a polarization direction different from the polarization axis of a polarizer, is absorbed by the polarizer, and does not transmit through the polarizer. This means that although influenced with the characteristics of the polarizer used, about 50 percent of light is absorbed by the polarizer, the quantity of the light usable for a liquid crystal picture display or the like decreases so much, and a resulting picture displayed becomes dark. A brightness enhancement film does not enter the light with the polarizing direction absorbed by the polarizer into the polarizer but reflects the light once by the brightness enhancement film, and further makes the light reversed through the reflective layer or the like prepared in the backside to re-enter the light into the brightness enhancement film. By this above-mentioned repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, or the like. A polarized light reflected by the brightness enhancement film goes to the above described reflective layer or the like, and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; or the like may be mentioned.

Therefore, in the brightness enhancement film of a type that transmits a linearly polarized light having the predetermined polarization axis, by arranging the polarization axis of the transmitted light and entering the light into a polarizing plate as it is, the absorption loss by the polarizing plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

In addition, also in a cholesteric liquid-crystal layer, a layer reflecting a circularly polarized light in a wide wavelength ranges, such as a visible-light band, may be obtained by adopting a configuration structure in which two or more layers with different reflective wavelength are laminated together. Thus a transmitted circularly polarized light in a wide wavelength range may be obtained using this type of cholesteric liquid-crystal layer.

Examples of the polarization converting element include anisotropic reflective type polarizing elements and anisotropic scattering type polarizing elements. The anisotropic reflective type polarizing element is preferably a composite of: a certain material that has the property of reflecting one of left-handed and right-handed circularly polarized night beams and transmitting the other of the light beams, such as a cholesteric liquid crystal layer, specifically an alignment film of a cholesteric liquid crystal polymer, or the aligned liquid crystal layer supported on a base film; and a retardation plate having a retardation 0.25 times a certain wavelength within the reflection band of the above material. Alternatively, the anisotropic reflective type polarizing element is preferably a product that has the property of transmitting linearly polarized lights along a specific polarization axis and reflecting the other lights, such as a thin dielectric multilayer film or a laminate of multilayered thin films different in refractive index anisotropy.

Examples of the former include PCF series manufactured by NITTO DENKO CORPORATION. Examples of the latter include DBEF series manufactured by 3M. A reflective grid polarizer may also be preferably used as the anisotropic reflective type polarizing element. Specifically, such a polarizer may be Micro Wires manufactured by MOXTEK, Inc. On the other hand, for example, the anisotropic scattering type polarizing element may be DRPF manufactured by 3M.

The adhesive or pressure-sensitive adhesive layer is mainly used to fix the position of the optical member and remove an air layer in the process of laminating the optical films or forming an image display. The type of the adhesive or pressure-sensitive adhesive layer is generally classified into, but not limited to, a layer comprising an adhesive and a layer comprising a pressure-sensitive adhesive, which are selected and used depending on their properties. The adhesive or pressure-sensitive adhesive layer may contain fine particles to exhibit light-diffusing properties.

The adhesive may be made ready for adhesion by a process including the steps of applying or attaching a liquid solution that generally contains a polymer and a crosslinking agent and then drying the solution by heating, air blowing or any other method to solidify the materials. The post-drying thickness of the adhesive may be from about 30 to about 1000 nm. For example, an aqueous solution containing a vinyl alcohol polymer and a water-soluble crosslinking agent reactive therewith is preferably used as the adhesive for adhesion between the polarizer and the transparent protective layer.

The pressure-sensitive adhesive to be used generally has a higher viscosity than the above adhesive in the initial state and resists solidifying even when dried. Thus, the pressure-sensitive adhesive can be peeled off at a stage when too much time does not elapse after the application. Examples of such a pressure-sensitive adhesive that may be used include, but are not limited to, appropriate conventional products such as acrylic, silicone, polyester, polyurethane, polyether, or rubber pressure-sensitive adhesives. The pressure-sensitive adhesive preferably has a low moisture absorption coefficient and high heat resistance. In general, an acrylic pressure-sensitive adhesive is preferably used for the optical member. Examples thereof include a product prepared by blending an acrylic oligomer and a silane coupling agent into an acrylic polymer; and a product prepared by adding a photopolymerization initiator to an acrylic polymer and irradiating the mixture with ultraviolet light (UV). The post-drying thickness of the adhesion layer comprising the pressure-sensitive adhesive may vary from 5 μm to 1 mm and is generally from about 5 to about 50 μm, while a pressure-sensitive adhesive layer with a thickness of about 100 μm to about 1 mm may be formed using a method of polymerization by UV irradiation. The formation of such a relatively thick pressure-sensitive adhesive layer can improve the shock-reducing properties. Thus, the pressure-sensitive adhesive layer can absorb an impact caused by a collision with any other optical film, a panel or the like to be laminated so that the effect of preventing damage can be increased.

The acrylic polymer may be produced by copolymerizing a main monomer of alkyl(meth)acrylate and another monomer having a functional group reactive with a multifunctional compound. A carboxyl group may also be introduced into the acrylic polymer. The weight average molecular weight of the acrylic polymer may be at least 400,000, preferably from 1,000,000 to 2,000,000. The alkyl group of alkyl(meth)acrylate may have an average carbon number of about 1 to about 12. Examples of alkyl(meth)acrylate include methyl(meth)acrylate, ethyl(meth)acrylate, butyl(meth)acrylate, 2-ethylhexyl(meth)acrylate, and isooctyl(meth)acrylate. These may be used individually or in any combination.

Similarly to the acrylic polymer, the acrylic oligomer to be used may also comprise a main skeleton of an alkyl(meth)acrylate monomer unit and may be a copolymer of the above monomers.

The photopolymerization initiator to be used may be of any type. Examples thereof include Irgacure 907, Irgacure 184, Irgacure 651, and Irgacure 369 all manufactured by Ciba Specialty Chemicals Inc. The photopolymerization initiator is generally added in an amount of about 0.5 to about 30 parts by weight, based on 100 parts by weight of the components to be polymerized.

Examples of the silane coupling agent include vinyltriethoxysilane, vinyltris(β-methoxyethoxy)silane, γ-methacryloxypropyltrimethoxysilane, vinyltriacetoxysilane, γ-glycidoxypropyltrimethoxysilane, γ-glycidoxypropyltriethoxysilane, β-(3,4-epoxycyclohexyl)ethyltrimethoxysilane, γ-chloropropylmethoxysilane, vinyltrichlorosilane, γ-mercaptopropyltrimethoxysilane, γ-aminopropyltriethoxysilane, and N-β(aminoethyl)-γ-aminopropyltrimethoxysilane. One of these agents may be used alone, or two or more of these agents may be used in combination. In general, the silane coupling agent is preferably added in an amount of 0.01 to 5.0 parts by weight, based on 100 parts by weight of the acrylic polymer (solids content).

Examples of the method of forming the pressure-sensitive adhesive layer include, but are not limited to, a method including the steps of applying a pressure-sensitive adhesive solution to at least one side of the optical film and drying it; and a method including the steps of applying a pressure-sensitive adhesive composition onto a release film, drying it, irradiating it with UV to form a pressure-sensitive adhesive layer, attaching at least one side of the optical film through the pressure-sensitive adhesive layer, and then separating the release film so that only the pressure-sensitive adhesive layer is transferred. In this process, the pressure-sensitive adhesive composition to be applied onto the optical film or the release film may be previously irradiated with an appropriate dose of UV, as needed.

The pressure-sensitive adhesive layer is not completely solidified by the drying as described above. It is undesirable that the naked pressure-sensitive adhesive layer in contact with the air interface be subjected to storage, transportation or the like, because there is a risk of foreign material contamination or a risk of a deterioration of the pressure-sensitive adhesive. Thus, the release film layer is preferably provided in order to protect the pressure-sensitive adhesive layer until use.

The release film to be used may be an appropriate thin layer material such as a polymer film of polyethylene, polypropylene, polyethylene terephthalate, or the like, a rubber sheet, paper, a fabric, a nonwoven fabric, a net, a foam sheet, a metal foil, and a laminate of any combination thereof. If necessary, the surface of the release film has preferably undergone silicone treatment, long-chain alkyl treatment, fluorine treatment, or the like for improvement in release property from the pressure-sensitive adhesive.

The optical layer as described below is preferably laminated on the optical film or the resulting optical member as needed. In this case, the optical layer refers to a layer that is formed directly or through the adhesive or pressure-sensitive adhesive layer on the optical film or component and assists the function of the optical member or the image display. Examples of the optical layer include a variety of aligned liquid crystal layers having the property of controlling viewing angle compensation, birefringent properties or the like and a variety of surface treatment layers such as adhesion-facilitating treatment layers, hard-coat layers, anti-reflection layers, anti-sticking layers, diffusion layers, and antiglare layers.

Examples of the adhesion-facilitating treatment include dry treatment such as plasma treatment and corona treatment, chemical treatment such as alkali treatment, and coating treatment of applying an adhesion-facilitating material. Any appropriate material may be used as the adhesion-facilitating material depending on the substance to be attached, and for example, the method may use a polyol resin, a polycarboxylic acid resin, a polyester resin, or the like to form a coating with a thickness of about 0.01 to about 10 μm.

The hard-coat treatment typically includes, but is not limited to, applying a transparent resin to form a hard-coat layer for the prevention of damage to the surface of the polarizing plate and the like. The hard-coat layer formed by the hard-coat treatment should have high hard-coat properties (a pencil hardness of at least H according to JIS K 5400 (pencil hardness test)), sufficient strength, and high light transmittance. The hard-coat layer may be formed by coating the surface of the transparent protective layer with a cured film that is made from an appropriate ultraviolet-curable resin such as an acrylic, silicone, or polyester resin and has a high hardness, high sliding properties and the like. Anti-reflection processing is applied for the purpose of anti-reflection of outdoor daylight on the surface of a polarizing plate and it may be prepared by forming an anti-reflection film according to the conventional method or the like. Besides, a anti-sticking processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, or the like, and organic type fine particles comprising cross-linked of non-cross-linked polymers may be used. When forming fine concavo-convex structure on the surface, the amount of fine particle used is usually about 2 to 50 weight parts to the transparent resin 100 weight parts that forms the fine concavo-convex structure on the surface, and preferably 5 to 25 weight parts. An anti glare layer may serve as a diffusion layer (viewing angle expanding function or the like) for diffusing transmitting light through the polarizing plate and expanding a viewing angle or the like.

In addition, the anti-reflection layer, anti-sticking layer, diffusion layer, anti glare layer, or the like, may be built in the protective film itself, and also they may be prepared as an optical layer different from the protective layer. Each layer may also contain various types of fine particles with electrical conductivity or the like, inorganic or organic, spherical or indefinite-shaped fillers, leveling agents, thixotropic agents, antistatic agents, or the like, as needed.

The optical member of the invention may be produced by processing a long size optical film into circular shape by any appropriate method such as punching with a Thomson blade, wherein at least two pieces of the circular shape optical films can be obtained from the long size optical film. In this process, the circular Shape optical film AS preferably subjected to cutting of the peripheral side for the purpose of correcting defects such as small chipping and protrusion of the adhesive layer. This can prevent the optical member from cracking during transport or the like or prevent the contamination by undesirable adhesion of the adhesive layer. After the processing as described above, the circular shape product may be processed into a product of arbitrary shape and size. In general, the circular shape product is preferably processed into a rectangular shape product of arbitrary size. In this process, any appropriate processing method may be used similarly to the above, and the peripheral side is preferably subjected to the cutting process. In the case where a laminate of the optical films is used to form the optical member of the invention or in the case where the optical layer is laminated, the timing of the lamination may be any of the stages of the long size optical film, the circular shape optical film and the rectangular shape optical film. As described above, the lamination is particularly performed after the step (A) of processing into circular shape as in the production method (2) or (3), so that the direction of the optical his is not restricted in the lamination process and thus unexpected design change or more sophisticated optical design can be handled.

The optical member according to the invention is preferably used to form image displays such as liquid crystal displays (LCDs), electroluminescence displays (ELDs), plasma displays (PDs), and field emission displays (FEDs) or the like.

The optical member of the invention may preferably be used to form a variety of devices such as liquid crystal displays. For example, the optical member of the invention may be used for liquid crystal displays, such as reflective, transflective or transmissive/reflective liquid crystal displays, which comprise a liquid crystal cell and the polarizing plate placed on one side or both sides of the liquid crystal cell. The liquid crystal cell substrate may be any of a plastic substrate and a glass substrate. The liquid crystal display may use any appropriate type of liquid crystal cell such as an active matrix driving type such as a thin-film transistor type; and a simple matrix driving type such as a twisted nematic type and a super twisted nematic type.

If the polarizing plates or any other optical members are placed on both sides of the liquid crystal cell, they may be the same or different. Additionally, any other appropriate components such as a prism array sheet, a lens array sheet, a light diffusion plate, and a backlight may also be placed in one or more layers at an appropriate position to form a liquid crystal display.

Subsequently, organic electro luminescence display (OELD) will be explained. Generally, in OELD, a transparent electrode, an organic luminescence layer and a metal electrode are laminated on a transparent substrate in an order configuring an illuminant (organic electro luminescence (EL) illuminant). Here, an organic luminescence layer is a laminated material of various organic thin films, and much compositions with various combination are known, for example, a laminated material of hole injection layer comprising triphenylamine derivatives or the like, a luminescence layer comprising fluorescent organic solids, such as anthracene; a laminated material of electronic injection layer comprising such a luminescence layer and perylene derivatives, or the like; laminated material of these hole injection layers, luminescence layer, and electronic injection layer or the like.

OELD emits light based on a principle that positive hole and electron are injected into an organic luminescence layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in a intermediate process is the same as a mechanism in common diodes, and, as is expected, there is a strong non-linear relationship between electric current and luminescence strength accompanied by rectification nature to applied voltage.

In OELD, in order to take out luminescence in an organic luminescence layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In OELD of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from a surface of a transparent substrate and is transmitted through a transparent electrode and an organic luminescence layer and then is reflected by a metal electrode, appears in front surface side of the transparent substrate again, a display side of the OELD looks like mirror if viewed from outside.

In OELD containing an organic EL illuminant equipped with a transparent electrode on a surface side of an organic luminescence layer that emits light by impression of voltage, and at the same time equipped with a metal electrode on a back side of organic luminescence layer, a retardation plate may be installed between these transparent electrodes and a polarizing plate, while preparing the polarizing plate on the surface side of the transparent electrode.

Since the retardation plate and the polarizing plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarizing plate and the retardation plate is adjusted to π/4, the mirror surface of the metal electrode may be completely covered.

This means that only linearly polarized light component of the external light that enters as incident light into this OELD is transmitted with the work of polarizing plate. This linearly polarized light generally gives an elliptically polarized light by the retardation plate, and especially the retardation plate is a quarter wavelength plate, and moreover when the angle between the two polarization directions of the polarizing plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarizing plate, it cannot be transmitted through the polarizing plate. As the result, mirror surface of the metal electrode may be completely covered.

In PD, an electric discharge is generated in a diluted gas, particularly a gas mainly composed of neon, sealed in the panel, and vacuum ultraviolet radiation generated in this process causes fluorescence of the R, G and B fluorescent materials, which are put on the cells in the panel, to allow image display.

### EXAMPLES

The invention is more specifically described using Examples and Comparative Examples below, which are not intended to limit the scope of invention.

### Example 1

(Preparation of Polarizing Plate)

A long size polyvinyl alcohol (PVA) film was impregnated with iodine and stretched to form a polarizer with a width of 55 cm and a thickness of 30 μm. A polarizing plate was formed by bonding 80 μm-thick triacetylceliulose (TAC) films to both sides of the polarizer through a PVA adhesive layer with a post-drying thickness of about 1 μm. A release film made of a 25 μm-thick polyester (PE) film with its surface treated with a silicone release agent and an acrylic pressure-sensitive adhesive layer with a post-drying thickness of 20 μm was laminated on one side of the polarizing plate through the pressure-sensitive adhesive layer to prepare a polarizing plate. As shown in FIG. 1, 100 circular pieces were punched from the resulting polarizing plate with a perfect circle-shaped Thomson blade with a diameter of 480 mm.

(Preparation of Retardation Plate)

Similarly, a long size polycarbonate (PC) film was uniaxialiy stretched to form a long size retardation plate with a width of 52 cm. As shown in FIG. 1, 100 circular pieces were punched from the long size retardation plate with a perfect circle-shaped Thomson blade with a diameter of 480 mm.

(Lamination)

The release film was then separated from the polarizing plate. A circular shape optical member was prepared by laminating the polarizing plate and the retardation plate in such a manner that their optical axes made an angle of 60°.

### Example 2

Polarizing plates and retardation plates each with a diameter of 480 mm were prepared using the process of Example 1, and a circular shape optical member was prepared by laminating the polarizing plate and the retardation plate in such a manner that their optical axes made an angle of 40°.

### Comparative Example 1

A long size polarizing plate (55 cm in width) and a long size retardation plate (52 cm in width) were prepared using the process of Example 1. As shown in FIG. 4, 390 mm×270 mm rectangle pieces were then punched from the polarizing plate with a Thomson blade which was set such that the optical axis of the polarizing plate made an angle of 60°. The Thomson blade was then set such that the angle of the optical axis was 0° and rectangle pieces were punched from the retardation plate with the Thomason blade as shown in FIG. 5. The pieces of the polarizing plate and the retardation plate were then laminated in such a manner that these angles were aligned, so that a rectangular shape optical member was obtained.

### Comparative Example 2

A long size polarizing plate (55 cm in width) and a long size retardation plate (52 cm in width) were prepared using the process of Example 1. A Thomson blade was then set such that the optical axis of the polarizing plate made an angle of 40°, and 390 mm×270 mm rectangle pieces were punched from the polarizing plate with the Thomson blade. The Thomson blade was then set such that the angle of the optical axis was 0° and rectangle pieces were punched from the retardation plate with the Thomson blade as shown in FIG. 5. The pieces of the polarizing plate and the retardation plate were then laminated in such a manner that these angles were aligned, so that a rectangular shape optical member was obtained.

(Evaluation)

Table 1 shows the efficiency (area yield) of utilization of the long size optical member for the polarizing plate, the retardation plate or the optical member of the laminate thereof in each of Examples and Comparative Examples. Assuming that rectangular shape optical members are produced by a post-process, the number of the 30 mm×30 mm square chips obtainable by cutting from a single piece of the optical member prepared in each of Examples and Comparative Examples is calculated and shown in Table 1.

TABLE 1

| | | | | Number of |
|---|---|---|---|---|
| | Area Yield | | | Obtainable |
| | Polarizing | Retardation | After | 30 × 30 mm |
| | Plate | Plate | Lamination | Chips (pieces) |
| Example 1 | 68.0% | 72.0% | 49.0% | 168 |
| Example 2 | 68.0% | 72.0% | 49.0% | |
| Comparative | 61.4% | 52.0% | 31.9% | 117 |
| Example 1 | | | | |
| Comparative | 45.6% | 52.0% | 23.7% | |
| Example 2 | | | | |

The results in Table 1 shows that the area yield and utilization efficiency are higher in Examples where circular shapes are formed than in Comparative Examples where rectangular shapes are formed in a conventional manner. This should be because the circular shape optical member of the invention is not affected by axis angle, while the size of the optical member to be produced in Comparative Examples is restricted by the width of the long size optical member and by the axis angle in the process of preparing rectangular shape optical members. According to the invention, therefore, the resulting optical members can always have a relatively large area so that more chips (final products) can be obtained in a single post-process.

According to the invention, processing can be performed in the same shape and size with the same blade type in the manufacturing process, and processing can also be performed without a change, adjustment or the like of the blade even when the type of the long size optical member is changed. Thus, production control can be easily performed, and the number of days taken until product shipment can be significantly reduced. It has been found that while the conventional manufacturing process as shown in Comparative Examples takes five days, the process according to the invention takes only three days. Thus, it is apparent that higher production efficiency can be achieved by the invention than by the conventional method.

### INDUSTRIAL APPLICABILITY

The optical member of the invention is suitable for use in image displays such as liquid crystal displays (LCDs), electroluminescence displays (ELDs), plasma displays (PDs), and field emission displays (FEDs).

1. An optical member, comprising at least one piece of an optical film, wherein the optical film has an optical axis and a circular outer shape.

2. The optical member according to claim 1, wherein the optical film further comprises at least one layer selected from an optical layer, an adhesive layer and a pressure-sensitive adhesive layer.

3. The optical member according to claim 1, wherein an in-plane aspect ratio (maximum length/minimum length) of the circular shape is 2 or less.

4. The optical member according to claim 1, wherein the optical film comprises at least one selected from a polarizing plate, a retardation plate, a viewing angle compensation film, a brightness enhancement film, and a polarization-converting element.

5. The optical member according to claim 1, wherein the optical film is a laminate comprising at least two optical films.

6. The optical member according to claim 5, wherein the optical film is a laminate comprising a polarizing plate and another optical film of at least one element that is other than the polarizing plate and selected from a retardation plate, a viewing angle compensation film, a brightness enhancement film, and a polarization-converting element.

7. A method of producing an optical member, comprising the steps of:
(A) processing a long size optical film having an optical axis into a circular shape; and
(B) processing the optical film processed into the circular shape into an arbitrary shape.

8. The method of producing the optical member according to claim 7, wherein the optical film further comprises at least one layer selected from an optical layer, an adhesive layer and a pressure-sensitive adhesive layer.

9. The method of producing the optical member according to claim 7, wherein an in-plane aspect ratio (maximum length/minimum length) of the circular shape in the step (A) is 2 or less.

10. The method of producing the optical member according to claim 7, wherein the arbitrary shape in the step (B) is a rectangular shape.

11. The method of producing the optical member according to claim 7, wherein the optical film comprises at least one selected from a polarizing plate, a retardation plate, a viewing angle compensation film, a brightness enhancement film, and a polarization-converting element.

12. The method of producing the optical member according to claim 7, wherein the optical film is a laminate comprising at least two optical films.

13. The method of producing the optical member according to claim 12, wherein the optical film is a laminate comprising a polarizing plate and another optical film of at least one element that is other than the polarizing plate and selected from a retardation plate, a viewing angle compensation film, a brightness enhancement film, and a polarization-converting element.

14. A method of producing an optical member comprising a laminate having at least two optical films, comprising the steps of:
(A) processing each of at least two optical films into a circular shape;
(C) laminating the at least two optical film processed into the circular shape obtained in the step (A); and
(B) processing the laminated optical films obtained in the step (C) into an arbitrary shape, the step (A) comprising at least the steps of:
(A1) processing a first long size optical film having an optical axis into a circular shape; and
(A2) processing a second long size optical film having an optical axis into a circular shape, and
the step (C) comprising at least the step of:
laminating the first and the second optical films processed into the circular shapes such that their optical axes make a prescribed angle.

15. A method of producing an optical member comprising a laminate having at least two optical films, comprising the steps of:
(A) processing each of at least two optical films into a circular shape;
(B) further processing each of the at least two optical film processed into the circular shape obtained in the step (A) into an arbitrary shape; and
(C) laminating the at least two arbitrary shaped optical films obtained in the step (B);
the step (A) comprising at least the steps of:
(A1) processing a first long size optical film having an optical axis into a first circular shape; and
(A2) processing a second long size optical film having an optical axis into a second circular shape, and
the step (C) comprising at least the step of:
laminating the first and the second optical film processed into the arbitrary shape such that their optical axes make a prescribed angle.

16. The method of producing the optical member according to claim 14, wherein the optical film comprises at least one layer selected from an optical layer, an adhesive layer and a pressure-sensitive adhesive layer.

17. The method of producing the optical member according to claim 14, wherein an in-plane aspect ratio (maximum length/minimum length) of the circular shape in the step (A) is 2 or less.

18. The method of producing the optical member according to claim 14, wherein the arbitrary shape in the step (B) is a rectangular shape.

19. The method of producing the optical member according to claim 14, wherein the optical film is at least one selected from a polarizing plate, a retardation plate, a viewing angle compensation film, a brightness enhancement film, and a polarization-converting element.

20. The method of producing the optical member according to claim 14, wherein the first optical film is a polarizing plate or a retardation plate, and the second optical film is other than the polarizing plate and at least one selected from a retardation plate, a viewing angle compensation film, a brightness enhancement film, and a polarization-converting element.

21. An optical member produced by the method according to claim 7.

22. An image display, comprising the optical member according to claim 1.
